(19) United States
(12) Patent Application Publication
(10) Pub. No.: US 2009/0193395 A1
(43) Pub. Date: Jul. 30, 2009

(54) SOFTWARE TESTING AND DEVELOPMENT METHODOLOGY USING MATURITY LEVELS

(75) Inventor: Tirrell Payton, Orlando, FL (US)

Correspondence Address: BEYER LAW GROUP LLP/YAHOO, PO BOX 1687, CUPERTINO, CA, 95015-1687, US

(73) Assignee: Yahoo! Inc., Sunnyvale, CA (US)

(21) Appl. No.: 12/019,358

(22) Filed: Jan. 24, 2008

(51) Int. Cl. G06F 9/44

(52) U.S. Cl. 717/124

(57) ABSTRACT

A software development methodology is to develop a software product including a plurality of units. Unit tests are generated according to a unit test framework. The unit test framework comprises a plurality of subsequently narrowing maturity levels, each maturity level outlining how a unit test at that level should be defined based on what functionality of the plurality of units should be tested and how that functionality should be tested. Each subsequent maturity level tests functionality at a more detailed level than functionality at a previous maturity level. The plurality of units are developed, and the unit tests are executed. A top maturity level includes testing whether each unit performs a function based on existence of strictly expected conditions. Maturity levels below the top maturity level include testing dependencies among the plurality of units, testing for exceptions of object functions and function dependencies, and testing for functionality to be later included in the software product.

### BACKGROUND

Software testing is a process by which it in ensured that software is operating as it is intended to operate. It is widely recognized that the later in development a bug is recognized, the more it costs to fix that bug. Conversely, the earlier in development a bug can be found, fixes for the bug are faster and less expensive. In addition, it has been recognized that problems with a system architecture can lead to substandard systems and outright project failures.

It is difficult for software programmers to test their own code, since it can be difficult for the “creator” of the software to judge the code objectively. One approach to address this difficulty has been to use software testers who are different from the software programmers. Generally, these testers only begin testing the software after it has been fully developed or relatively late in the development process.

### SUMMARY

A software development methodology is to develop a software product including a plurality of units. Unit tests are generated according to a unit test framework. The unit test framework comprises a plurality of subsequently narrowing maturity levels, each maturity level outlining how a unit test at that level should be defined based on what functionality of the plurality of units should be tested and how that functionality should be tested. Each subsequent maturity level tests functionality at a more detailed level than functionality at a previous maturity level.

The plurality of units are developed, and the unit tests are executed. A top maturity level includes testing whether each unit performs a function based on existence of strictly expected conditions. Maturity levels below the top maturity level include testing dependencies among the plurality of units, testing for exceptions of object functions and function dependencies, and testing for functionality to be later included in the software product. Functionality to be later included in the software product may include, for example, refactoring of functionality of a unit, additional functionality of a unit, or an additional unit.

A mechanism is therefore provided to facilitate a process for programmers to test the code they have programmed and/or are going to program, but that also imposes some objectivity on the testing process.

### BRIEF DESCRIPTION OF THE DRAWINGS

FIG. 1 illustrates a software system (in this case, an object) in which there are four functions.

FIG. 2 schematically illustrates a Level 1 Unit Testing of the FIG. 1 object.

FIG. 3 illustrates Level 2 Dependency Testing of the FIG. 1 object.

FIG. 4 illustrates Level 3 Unit Testing of the FIG. 1 object, to test extraneous exceptions of the object functions and function dependencies.

FIG. 5 illustrates an example of Level 4 Unit Testing of the FIG. 1 object, to test product backlog items, to-do items, and new functionality.

FIG. 6 is a flowchart illustrating an example method for software development using the above-described Unit Test methodology.

FIG. 7 is a simplified diagram of a network environment in which specific embodiments of the present invention may be implemented.

### DETAILED DESCRIPTION

The inventor has realized the desirability of providing a software testing framework that not only facilitates a process for programmers to test the code they have programmed, but that also imposes some objectivity on the testing process. In accordance with an aspect, then, a unit-level software testing framework is provided that provides “maturity levels” by which unit level software testing should be carried out. In general, the maturity levels provide a prioritized list of functionality to be tested and a method by which to prioritize testing activities.

In some examples, such a unit level software testing framework removes or minimizes a personal judgment aspect from the process of creating unit tests, which should make it easier for a software developer at any level to create effective unit tests. In addition, the framework may describe with some precision what should be tested and how. The unit testing framework can provide a method and systematic approach for finding deficiencies in a software architecture.

In one example, there are four such maturity levels. Basically, a Level 1 unit tests represent how the code should work based on ‘a perfect world’ (i.e., does not test for anything except strictly expected conditions). Level 2 unit tests characterize behavior in the absence of dependencies. Level 3 tests exceptions, corner cases, and ‘what happens if’ scenarios. Level 4—refactoring, additional functions, and new requirements—should be expressed as failed unit tests, as this can ensure testability up front and make the code easier to maintain.

The unit test mindset results in a change in thinking and a shifting of roles (where testing can be performed by the coders, as opposed to specialized testers). This ultimately results in better code. Unit tests are not ‘finished’, and should not be looked upon as a finite task as long as the units (objects) themselves are being maintained and refactored. Developers should actively look for ways to break their own code and express those ways as unit tests.

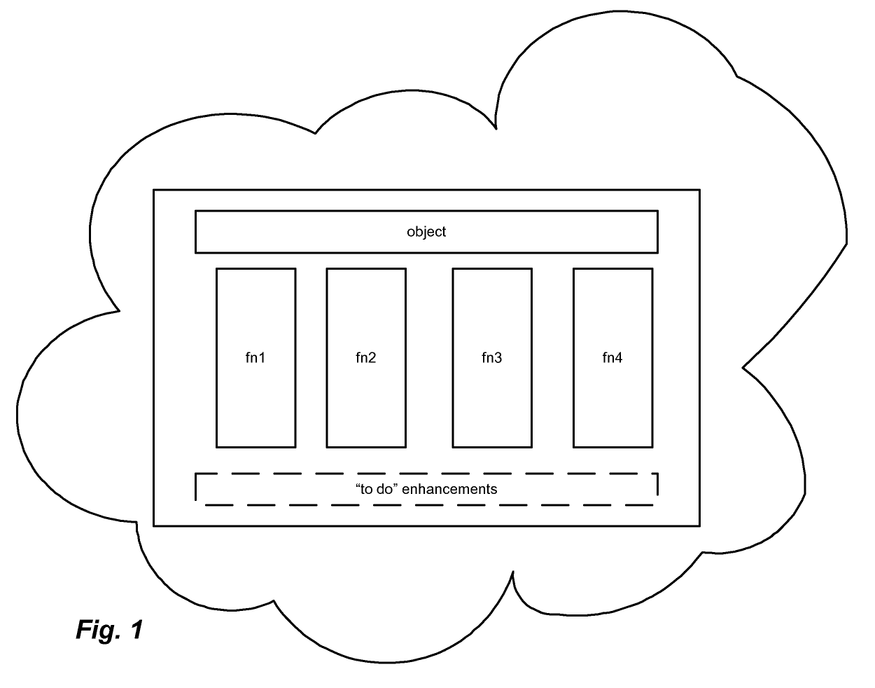

Code combinations, and therefore unit test permutations, can quickly become a daunting number. For example, FIG. 1 illustrates a software system (in this case, an object) in which there are four functions. The functions typically have dependencies and, additionally, a developer may identify “what if” scenarios.

For example, the functions correspond to functions the object is intended to perform. The dependencies are external conditions that need to be met in order for the object to perform the functions it is intended to perform. The “what if” scenarios are scenarios in which an improbable condition occurs.

Finally, it is recognized that software development is often ongoing. Thus, a developer may have identified “to do” enhancements to an object, but may not have implemented them yet.

Having discussed various maturity levels of a software object, we now discuss an example of a unit testing framework that is based on maturity levels, as applied to the FIG. 1 object. As mentioned above, in the example, there are four functions and eleven identified dependencies. Furthermore, the developer has identified seventeen ‘What happens if?’ scenarios. Therefore there are 748 different possible code paths to test. While one hundred percent test coverage is the goal, in many cases it is not practical to predicate project timelines on this goal. There is a lot of utility to be gained from a core testing at two levels of maturity (in the example, called Level 1 and Level 2), and ‘kaizen’ (continuous improvement) plans and metrics can be put into place for ensuring that the test plan coverage (for Level 3 and Level 4, in the example) increases over time. In one example, a minimum of testing is required for delivery that includes all Level 1 and identified Level 2 unit tests.

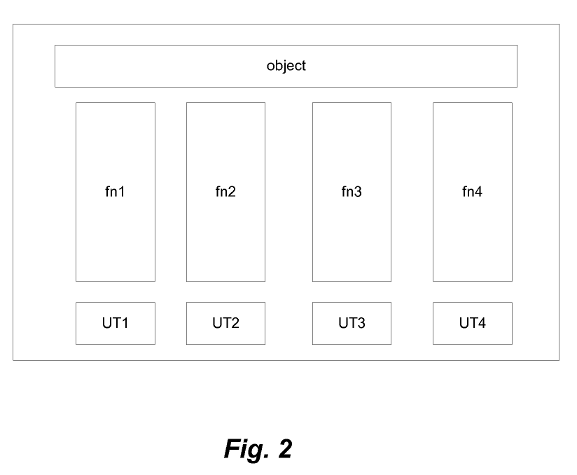

FIG. 2 schematically illustrates an Level 1 maturity of unit testing. Referring to FIG. 2, each function Fnx (where, in FIG. 2, x is an integer between 1 and 4) has a corresponding Level 1 unit test. In the FIG. 2 example, each unit test is referred to as UTx, where “x” corresponds to the “x” in the function designation Fnx. For example, generically, unit test UTx corresponds to function Fnx. As a specific example, unit test UT3 corresponds to function Fn3.

Each Level 1 unit test is directed to the “What does it do?” of the function corresponding to that Level 1 unit test. Unit test maturity Level 1 can be categorized under the question ‘What does it do?’ This level of testing addresses the basic functionality of the unit. Although this is the least mature of the testing levels, it provides the foundation for the rest of the unit testing.

For example, assume that the object of FIG. 2 is a car, and the following functions are the four functions of the car object:
Function 1: int iStartEngine //starts engine, returns 0 upon success
Function 2: int iAccelerate //accelerates by 5, returns 0 upon success
Function 3: int iDecelerate //decelerates by 5, returns 0 upon success
Function 4: int iStopEngine //stops engine, returns 0 upon success

The Level 1 Unit Testing for this car object, in the bulleted list below, directly tests the four functions to make sure they work on a basic level.
CPPUNIT_ASSERT (iStartEngine( )==0)
CPPUNIT_ASSERT (iAccelerate( )==0)
CPPUNIT_ASSERT (iDecelerate( )==0)
CPPUNIT_ASSERT (iStopEngine( )==0)
   With the Level 1 Unit Testing passed, it is known that the functions work, but not much more.

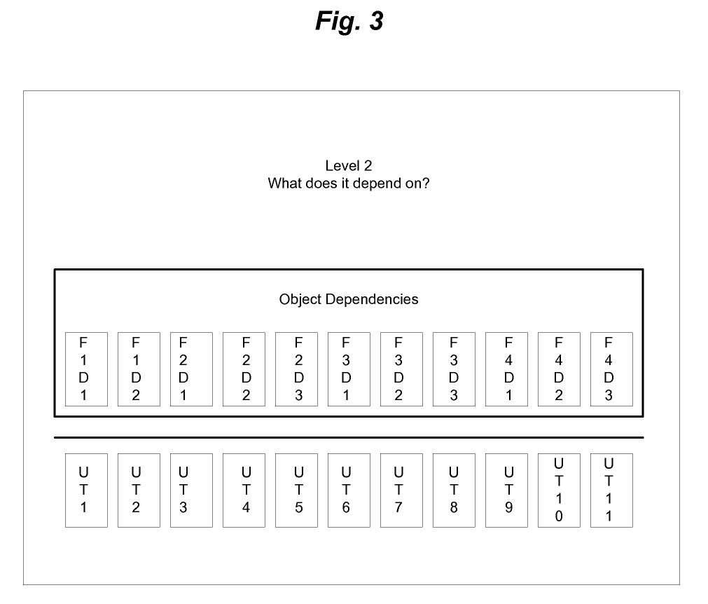

FIG. 3 illustrates Level 2 Dependency Testing. The object dependencies are indicated in FIG. 3 as FiDj, where “i” is an indication of the function (e.g., referring to FIG. 2, “i” may be an integer from 1 to 4). Additionally, “j” is an indication of the dependency for the function “i.” Referring to FIG. 3, there are eleven unit tests (UT1 to UTI11), one unit test for each dependency.

In describing FIG. 3, we continue to use the “car” object from the previous example, with Function 1, Function 2, Function 3 and Function 4. The Level 2 Unit Testing for this car object will test the behavior of the 4 functions based on dependencies. Five examples of Level 2 Unit Testing are set forth below:

Example 1 tests the behavior of the iStartEngine function and its dependency on a key being inserted.

//Example 1
Bool bIsKeyInserted = 0
//The key is not inserted
CPPUNIT_ASSERT(iStartEngine( ) == 10)
//Error code 10, no key inserted

Example 2 tests the behavior of the iStartEngine function and its dependency on the gas tank not being empty.

//Example 2
Bool bIsGastankEmpty = 1
//the gas tank is empty
CPPUNIT_ASSERT (iStartEngine( ) == 20)
//Error code 20, gas tank is empty

Example 3 tests the behavior of the iAccelerate function and its dependency on the engine having been started.

//Example 3
iStartEngine != 0
//whether it's the fault of the
//key not being inserted, or the
//gas tank being empty, we know
//the engine is not started.
CPPUNIT_ASSERT (iAccelerate( ) == 30)
//Error code 30, engine is not started

Example 4 tests the behavior of the iDecelerate function and its dependency on the engine having been started.

//Example 4
iStartEngine != 0
CPPUNIT_ASSERT (iDecelerate( ) == 30)
//Error code 30, engine is not started

Finally, example 5 tests the behavior of the iStopEngine function and its dependency on the engine having been started.

//Example 5
iStartEngine != 0
CPPUNIT_ASSERT (iStopEngine( ) == 30)
//Error code 30, engine is not started

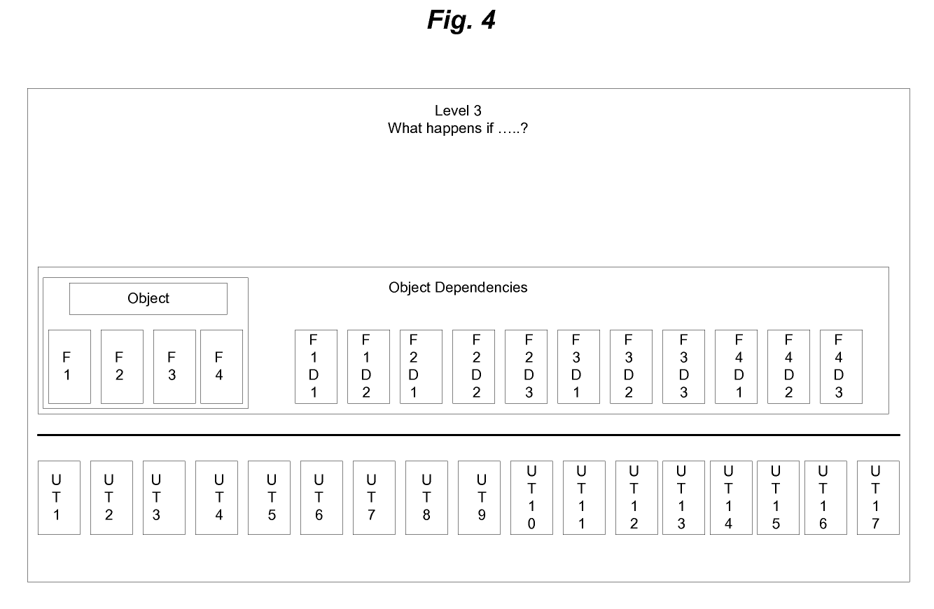

Referring now to FIG. 4, Level 3 Unit Testing tests extraneous exceptions of the object functions and function dependencies. Level 3 unit tests can be categorized under the question “What happens if . . . ?” Level 3 Unit testing may involve some imagination and creativity for a coder to think of the cases, and not all cases may be covered on the first try. In general, the object may be used, continuously improved, and made more robust over time. The unit tests may be correspondingly used, improved and made more robust.

Examples of Level 3 Unit Testing tests are:

//what happens if the engine has been started and I run out of gas?
//what happens if the engine has been started and I try to start it again?
//what happens if I try to accelerate and I pull the key out?
//what happens if I try to accelerate and I run out of gas?
//what happens if I try to decelerate and speed == 0?
//what happens if I try to decelerate and the engine is stopped?
//what happens if I try to stop the engine and my speed > 0?
//what happens if I try to stop the engine and the engine is already
stopped?

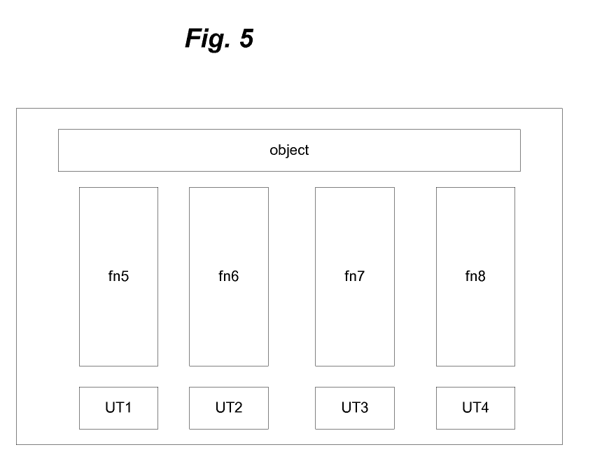

As shown in FIG. 5, Level 4 Unit Testing tests product backlog items, to-do items, and new functionality. These are assumed to fail all the time. If they do not fail, then they can be characterized and placed into the Level 1, Level 2, or Level 3 category.

Building on the object of the previous examples, the following functions are tested using Unit Testing maturity Level 4 tests.

Function 5: int iOpenWindow
//opens window, returns 0 upon success
Function 6: int iCloseWindow
//closes window, returns 0 upon success
Function 7: int iTurnOnLights
//turns on headlights, returns 0 upon success
Function 8: int iTurnOffLights
//turns off headlights, return 0 upon success.

The Level 4 Unit Testing for this car object will fail because they are backlog items.
CPPUNIT_ASSERT (iOpenWindow( )==0)
CPPUNIT_ASSERT (iCloseWindow( )==0)
CPPUNIT_ASSERT (iTurnOnLights( )==0)
CPPUNIT_ASSERT (iTurnOffLights( )==0)

In summary, then, it can be see that Level 1 unit tests represent how code is supposed to behave based on ‘a perfect world.’ Level 2 unit tests characterize behavior in the absence of dependencies. Exceptions, corner cases, and ‘what happens if’ scenarios are tested by Level 3 unit tests. Refactoring, additional functions, and new requirements may be expressed as failed unit tests (Level 4), thus maximizing the testability of these functions up front and making the code easier to maintain.

The unit test mindset utilizes a change in thinking and a shifting of roles, but ultimately results in better code. Unit tests are never ‘finished’, and are not to be looked upon as a finite task as long as the units (objects) themselves are being maintained and refactored. A developer will actively look for ways to break her own code and express those as unit tests.

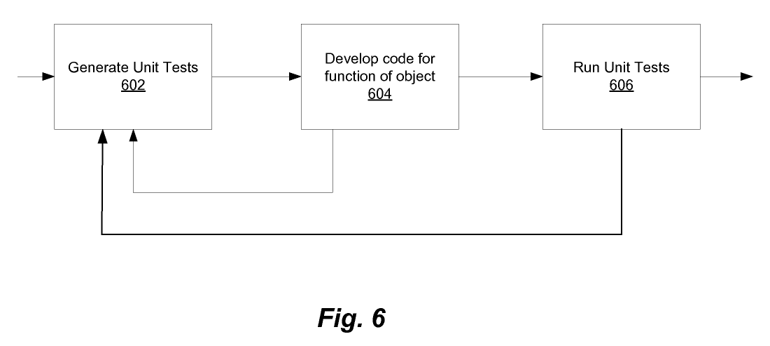

FIG. 6 is a flowchart illustrating an example method for software development using the above-described Unit Test methodology. Referring to FIG. 6, at 602, unit tests are generated. The unit tests may include, for example, unit tests at maturity level 4 (i.e., relative to refactoring of functions, additional functions and/or new requirements). At 604, code is developed to accomplish the function refactoring, additional functions and/or new requirements. At 606, unit tests are performed. After performing the unit tests at 606, additional unit tests may be generated at 602, such as relative to refactoring of functions, additional functions and/or new requirements).

Furthermore, at either 604 or 606, return may be made to 602 or 604, respectively. For example, at 604, code may be developed for a function of an object, and then at 602, unit tests may be generated for refactoring of the functions, additional functions and/or new requirements. As another example, at 606, unit tests may be run for a particular function or dependency and, based on the running of the unit tests, code for the function or dependency for which the unit tests are run may be further developed. The unit tests may be included as part of the software product that, for example, are not executed when the software product is in an operational, non-testing mode.

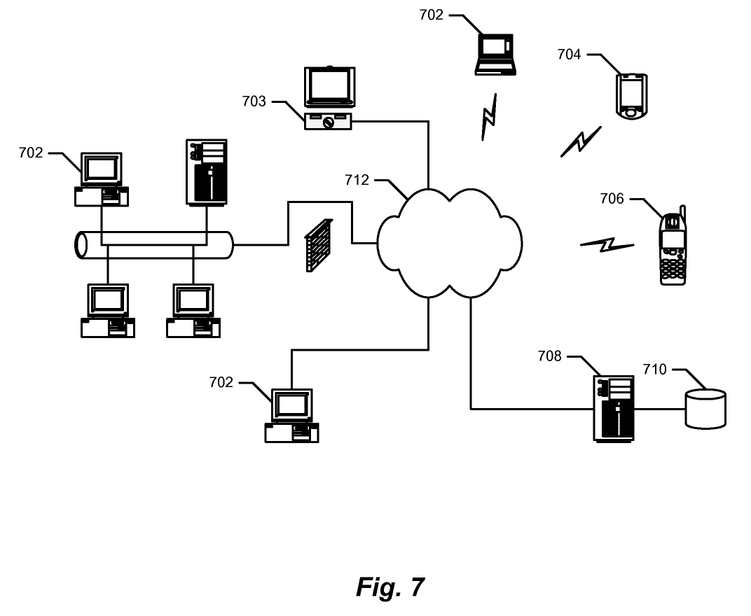

Embodiments of the present invention may be employed to facilitate unit testing in any of a wide variety of computing contexts. For example, as illustrated in FIG. 7, implementations are contemplated in which users may interact with a diverse network environment via any type of computer (e.g., desktop, laptop, tablet, etc.) 702, media computing platforms 703 (e.g., cable and satellite set top boxes and digital video recorders), handheld computing devices (e.g., PDAs) 704, cell phones 706, or any other type of computing or communication platform.

According to various embodiments, applications may be executed locally, remotely or a combination of both. The remote aspect is illustrated in FIG. 7 by server 708 and data store 710 which, as will be understood, may correspond to multiple distributed devices and data stores.

The various aspects of the invention may also be practiced in a wide variety of network environments (represented by network 712) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

We have described a mechanism for software testing. More particularly, we have described a mechanism for facilitates a process for programmers to test the code they have programmed, but that also imposes some objectivity on the testing process.

What is claimed is:

1. A method of software testing for use with a software product including a plurality of units, comprising:
providing a unit test framework comprising a plurality of subsequently narrowing maturity levels, each maturity level outlining how a unit test at that level should be defined based on what functionality of the plurality of units should be tested and how that functionality should be tested, and each subsequent maturity level testing functionality at a more detailed level than functionality at a previous maturity level;
preparing unit tests for a portion of the software product based on the unit test framework; and
executing the unit tests for the portion of the software product.

2. The method of claim 1, wherein a top maturity level includes testing whether each unit performs a function based on existence of strictly expected conditions.

3. The method of claim 1, wherein a maturity level below a top maturity level includes testing dependencies among the plurality of units.

4. The method of claim 1, wherein a maturity level below a top maturity level tests for extraneous exceptions of object functions and function dependencies.

5. The method of claim 1, wherein a maturity level below a top maturity level tests for functionality to be later included in the software product.

6. The method of claim 5, wherein the functionality to be later included in the software product includes at least one of the group consisting of a refactoring of functionality of a unit, additional functionality of a unit, or an additional unit.

7. A software development methodology to develop a software product including a plurality of units, comprising:
generating unit tests according to a unit test framework, the unit test framework comprising a plurality of subsequently narrowing maturity levels, each maturity level outlining how a unit test at that level should be defined based on what functionality of the plurality of units should be tested and how that functionality should be tested, and each subsequent maturity level testing functionality at a more detailed level than functionality at a previous maturity level;
developing the plurality of units; and
executing the unit tests.

8. The software development methodology of claim 7, wherein:
at least some of the unit tests are directed to functionality already in the plurality of units at the time the unit tests are generated; and
at least some of the unit tests are directed to functionality expected to be changed or created subsequent to the time the unit tests are generated.

9. The software development methodology of claim 7, wherein:
the maturity levels include a top maturity level to test whether each unit performs a function based on existence of strictly expected conditions.

10. The software development methodology of claim 9, wherein:
a maturity level below a top maturity level includes testing dependencies among the plurality of units.

11. The software development methodology of claim 9, wherein a maturity level below a top maturity level tests for extraneous exceptions of object functions and function dependencies.

12. The software development methodology of claim 9, wherein a maturity level below a top maturity level tests for functionality to be later included in the software product.

13. The software development methodology of claim 12, wherein the functionality to be later included in the software product includes at least one of the group consisting of a refactoring of functionality of a unit, additional functionality of a unit, or an additional unit.

14. A system configured for testing a software product, wherein the software product includes a plurality of units, the system comprising at least one computing device configured to:
execute units tests for a portion of the software product, the unit tests conforming to a unit test framework comprising a plurality of subsequently narrowing maturity levels, each maturity level outlining how a unit test at that level should be defined based on what functional of the plurality of unit tests should be tested and how that functionality should be tested, and each subsequent maturity level testing functionality at a more detailed level than functionality at a previous maturity level; and
provide indication of success of the unit tests.

15. The system of claim 14, wherein a top maturity level includes testing whether each unit performs a function based on existence of strictly expected conditions.

16. The system of claim 14, wherein a maturity level below a top maturity level includes testing dependencies among the plurality of units.

17. The system of claim 14, wherein a maturity level below a top maturity level tests for extraneous exceptions of object functions and function dependencies.

18. The system of claim 14, wherein a maturity level below a top maturity level tests for functionality to be later included in the software product.

19. The system of claim 14, wherein the system is further configured to:
cause the software product to operate without executing the unit tests.
